(19) United States
(12) Patent Application Publication
(10) Pub. No.: US 2014/0322604 A1
(43) Pub. Date: Oct. 30, 2014

(54) ELECTRODE-ACTIVE MATERIAL, ELECTRODE MATERIAL, ELECTRODE, LITHIUM ION BATTERY, AND METHOD OF PRODUCING ELECTRODE MATERIAL

(71) Applicant: SUMITOMO OSAKA CEMENT CO., LTD., Tokyo (JP)

(72) Inventors: Takao KITAGAWA, Tokyo (JP); Akinori YAMAZAKI, Tokyo (JP)

(73) Assignee: SUMITOMO OSAKA CEMENT CO., LTD., Tokyo (JP)

(21) Appl. No.: 14/259,188

(22) Filed: Apr. 23, 2014

(30) Foreign Application Priority Data
Apr. 26, 2013 (JP) 2013-093968

(51) Int. Cl. H01M 4/58; H01M 4/62; C01B 25/45; H01M 4/36

(52) U.S. Cl. CPC H01M 4/5825; H01M 4/366; H01M 4/625; H01M 4/5815; C01B 25/45
USPC 429/221; 252/182.1

(57) ABSTRACT

An electrode-active material includes sulfur or a sulfur compound in particles represented by LiₓA_{y}D_{z}PO₄ (wherein A represents one or two or more elements selected from the group consisting of Co, Mn, Ni, Fe, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x<2; 0<y<1; and 0≦z<1.5), in which a sulfur content in the particles is high in the centers of the particles and is low in the vicinity of surfaces of the particles.

### BACKGROUND OF THE INVENTION

1. Field of the Invention

The present invention relates to an electrode-active material, an electrode material, an electrode, a lithium ion battery, and a method of producing an electrode material, particularly, to a cathode material for a battery, an electrode-active material and an electrode material which are suitably used for a cathode material for a lithium ion battery, an electrode including this electrode material, and a lithium ion battery including a cathode formed of this electrode.

2. Description of Related Art

Recently, a reduction in environmental burden has been required, and zero emissions and the post-petroleum society have been promoted nationwide. In particular, secondary batteries which are used in electric vehicles, portable electronic equipment, and the like are in the limelight and are positioned as being in a field responsible for the realization of a clean energy society. As representative examples of such secondary batteries, lead storage batteries, alkali storage batteries, or lithium ion batteries are known. In particular, lithium ion batteries can be reduced in size and weight and increased in capacity, and have superior properties such as high output and high energy density. Therefore, lithium ion batteries have been studied as a high-output power supply of electric vehicles, electric tools, or the like, and next-generation lithium ion battery materials have been actively developed all over the world.

As a cathode-active material for a lithium ion battery which has been putinto practice, LiCoO₂ or LiMnO₂ is commonly used. However, cobalt (Co) is a rare resource which is unevenly distributed on earth and thus, when being used in a large amount, has a problem in that a stable supply is difficult due to increased production costs. As an alternative cathode-active material to LiCoO₂, the research and development of a cathode-active material such as spinel LiMn₂O₄, ternary system LiNi_{1/3}Mn_{1/3}Co_{1/3}O₂, lithium iron oxide (LiFeO₂), or lithium iron phosphate (LiFePO₄) have actively progressed.

Among these materials, LiFePO₄ having an olivine structure has attracted attention as a cathode material having no problems with safety, amount of resource, and production cost.

An olivine-based cathode material represented by LiFePO₄ contains phosphorus as a constituent element and forms a strong covalent bond with oxygen. As a result, compared to a cathode material such as LiCoO₂, oxygen is not emitted at a high temperature, there is no risk of ignition caused by oxygen decomposition of an electrolytic solution, and the stability is high.

However, in LiFePO₄ having such advantageous effects, there is a problem of low electron conductivity. It is presumed that this problem occurs due to slow lithium ion diffusion in the active material and low electron conductivity, which are caused by the structure.

As an electrode material with improved electron conductivity, for example, an electrode material is disclosed which is obtained by allowing primary particles of an electrode-active material formed of LiₓA_{y}D_{z}PO₄ (wherein A represents one or two or more elements selected from the group consisting of Co, Mn, Ni, Fe, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x<2; 0<y<1; and 0≦z<1.5) to aggregate such that secondary particles are formed and allowing carbon to be interposed between the primary particles as an electron-conductive material such that a surface of the electrode-active material is coated with a carbon coating film.

In addition, as a method of producing such an electrode material, a method is disclosed, the method including: spraying and drying a slurry containing an electrode-active material or a precursor thereof and an organic compound to forma granulated body; and heating this granulated body in a non-oxidizing atmosphere in a temperature range from 500° C. to 1000° C. (refer to Japanese Laid-open Patent Publication Nos. 2004-014340, 2004-014341, and 2001-015111).

However, even in the above-described electrode material which is prepared by allowing primary particles of an electrode-active material formed of LiₓA_{y}D_{z}PO₄ to aggregate such that secondary particles are formed and allowing carbon to be interposed between the primary particles such that a surface of the electrode-active material is coated with a carbon coating film, sufficient electron conductivity is not obtained, and further improvement in electron conductivity and diffusibility of Li inside particles is required.

To that end, in order to improve either or both of the electron conductivity and the ion diffusibility of an electrode-active material, an electrode-active material to which a small amount of sulfur is added is disclosed (refer to Japanese Laid-open Patent Publication Nos. 2002-198050, 2005-050556, and 2006-339104)

In addition, an electrode material which is obtained by allowing primary particles of an electrode-active material, which has significantly improved electron conductivity by containing sulfur, to aggregate such that secondary particles are formed and allowing carbon to be interposed between the primary particles, is disclosed (refer to Japanese Laid-open Patent Publication No. 2010-161038).

### SUMMARY OF THE INVENTION

However, even in the electrode-active material containing sulfur, sufficient electron conductivity is not obtained, and the electron conductivity and the diffusibility of Li inside particles are insufficient for satisfying the requirements of the market. Accordingly, in the electrode-active material containing sulfur, battery characteristics are insufficient, and particularly improvement in discharge capacity at a high charge-discharge rate is required.

The invention has been made in order to solve the above-described problems, and an object thereof is to provide an electrode-active material and an electrode material having high electron conductivity and high diffusibility of Li inside particles; an electrode containing this electrode material; a lithium ion battery including a cathode formed of this electrode in which the discharge capacity at a high charge-discharge rate is high and the charge-discharge rate performance is sufficient; and a method of producing an electrode material having high electron conductivity and high diffusibility of Li inside particles.

As a result of thorough investigation for solving the above-described problems, the present inventors found that when a sulfur content in particles of an electrode-active material is high in the centers of the particles and is low in the vicinity of surfaces of the particles, the electron conductivity is improved and the diffusibility of Li inside the particles is improved, the electrode-active material being obtained by containing sulfur or a sulfur compound in the particles, the particles being represented by LiₓA_{y}D_{z}PO₄ (wherein A represents one or two or more elements selected from the group consisting of Co, Mn, Ni, Fe, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x<2; 0<y<1; and 0≦z<1.5). The present inventors also found that when an electrode is formed of an electrode material including the electrode-active material, the discharge capacity at a high charge-discharge rate is high and the charge-discharge rate performance is sufficient. Based on the above findings, the present invention has been completed.

That is, according to a first aspect of the invention, an electrode-active material is provided including sulfur or a sulfur compound in particles represented by LiₓA_{y}D_{z}PO₄ (wherein A represents one or two or more elements selected from the group consisting of Co, Mn, Ni, Fe, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x<2; 0<y<1; and 0≦z<1.5), in which a sulfur content in the particles is high in the centers of the particles and is low in the vicinity of surfaces of the particles.

In the electrode-active material according to the first aspect, it is preferable that the sulfur content be 100 ppm to 1000 ppm; and that when a total sulfur content of the particles is represented by St, a sulfur content in the vicinity of the surfaces of the particles which are dipped in hydrochloric acid having a mass ten times that of the particles and a pH of 3 for 5 minutes is represented by Sa1, and a sulfur content in the vicinity of the surfaces of the particles which are dipped in hydrochloric acid having a mass ten times that of the particles and a pH of 3 for 10 minutes is represented by Sa2, 0.01≦Sa1/St≦0.1 and 0.01≦Sa2/St≦0.2 be satisfied.

In the electrode-active material according to the first aspect, it is preferable that the surfaces of the particles be coated with a carbon coating film.

According to a second aspect of the invention, an electrode material is provided which is obtained by allowing primary particles of the above-described electrode-active material to aggregate such that secondary particles are formed and allowing carbon to be interposed between the primary particles, in which the sulfur content is 100 ppm to 1000 ppm, and when a total sulfur content of the primary particles is represented by St, a sulfur content in the vicinity of the surfaces of the primary particles which are dipped in hydrochloric acid having a mass ten times that of the primary particles and a pH of 3 for 5 minutes is represented by Sa1, and a sulfur content in the vicinity of the surfaces of the primary particles which are dipped in hydrochloric acid having a mass ten times that of the primary particles and a pH of 3 for 10 minutes is represented by Sa2, 0.01≦Sa1/St≦0.1 and 0.01≦Sa2/St≦0.2 are satisfied.

According to a third aspect of the invention, an electrode is provided including the above-described electrode material.

According to a fourth aspect of the invention, a lithium ion battery is provided including a cathode formed of the above-described electrode.

According to a fifth aspect of the invention, a method of producing an electrode material is provided, including: preparing a slurry containing an electrode-active material or a precursor thereof and an organic compound, the electrode-active material containing sulfur or a sulfur compound in a compound represented by LiₓA_{y}D_{z}PO₄ (wherein A represents one or two or more elements selected from the group consisting of Co, Mn, Ni, Fe, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x<2; 0<y<1; and 0≦z<1.5); spraying and drying the slurry to form a granulated body; and heating the granulated body in a reducing atmosphere in a temperature range from 500° C. to 1000° C.

The electrode-active material according to the first aspect includes sulfur or a sulfur compound in particles represented by LiₓA_{y}D_{z}PO₄ (wherein A represents one or two or more elements selected from the group consisting of Co, Mn, Ni, Fe, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x<2; 0<y<1; and 0≦z<1.5), in which a sulfur content in the particles is high in the centers of the particles and is low in the vicinity of surfaces of the particles. As a result, the electron conductivity can be improved, and the diffusibility of lithium ions inside the particles can be improved. In addition, regarding the sulfur content, the sulfur content in the particles is high in the centers of the particles and is low in the vicinity of surfaces of the particles. As a result, the ratio of sulfur in the vicinity of the surfaces of the particles is decreased, and thus the discharge capacity can be improved.

The electrode material according to the second aspect is obtained by allowing primary particles of the above-described electrode-active material to aggregate such that secondary particles are formed and allowing carbon to be interposed between the primary particles, in which the sulfur content is 100 ppm to 1000 ppm, and when a total sulfur content of the primary particles is represented by St, a sulfur content in the vicinity of the surfaces of the primary particles which are dipped in hydrochloric acid having a mass ten times that of the primary particles and a pH of 3 for 5 minutes is represented by Sa1, and a sulfur content in the vicinity of the surfaces of the primary particles which are dipped in hydrochloric acid having a mass ten times that of the primary particles and a pH of 3 for 10 minutes is represented by Sa2, 0.01≦Sa1/St≦0.1 and 0.01≦Sa2/St≦0.2 are satisfied. As a result, the electron conductivity can be improved, and the diffusibility of lithium ions inside the particles can be improved.

In addition, in order to satisfy 0.01≦Sa1/St≦0.1 and 0.01≦Sa2/St≦0.2, the total sulfur content St of the primary particles, the sulfur content Sa1 in the vicinity of the surfaces of the primary particles which are dipped in hydrochloric acid having a pH of 3 for 5 minutes, and the sulfur content Sa2 in the vicinity of the surfaces of the primary particles which are dipped in hydrochloric acid having a pH of 3 for 10 minutes are limited. As a result, the ratio of sulfur in the vicinity of the surfaces of the particles is decreased, and thus the discharge capacity can be improved.

The electrode according to the third aspect includes the above-described electrode material. As a result, the discharge capacity at a high charge-discharge rate can be increased, and sufficient charge-discharge rate performance can be obtained.

The lithium ion battery according to the fourth aspect includes a cathode formed of the above-described electrode. As a result, the discharge capacity at a high charge-discharge rate can be increased, and sufficient charge-discharge rate performance can be obtained.

The method of producing an electrode material according to the fifth aspect includes: preparing a slurry containing an electrode-active material or a precursor thereof and an organic compound, the electrode-active material containing sulfur or a sulfur compound in a compound represented by LiₓA_{y}D_{z}PO₄ (wherein A represents one or two or more elements selected from the group consisting of Co, Mn, Ni, Fe, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x<2; 0<y<1; and 0≦z<1.5); spraying and drying the slurry to form a granulated body; and heating the granulated body in a reducing atmosphere in a temperature range from 500° C. to 1000° C. As a result, by heating the electrode-active material in a atmosphere in a state where sulfur is uniformly distributed in the electrode-active material, sulfur is removed from the surfaces of the particles such that the sulfur distribution in the particles can be controlled to be high in the centers of the particles and be low in the vicinity of the surfaces of the particles. Accordingly, an electrode material capable of improving the electron conductivity and the diffusibility of lithium ions inside the particles can be produced with high efficiency at a low cost.

### BRIEF DESCRIPTION OF THE DRAWINGS

FIG. 1 is a diagram illustrating XPS measurement results of particle surfaces in each of Example 4 according to the invention and Comparative Example.

FIG. 2 is a diagram illustrating XPS measurement results of particle surfaces in each of Example 4 according to the invention and Comparative Example.

### DETAILED DESCRIPTION OF THE INVENTION

Embodiments of an electrode-active material, an electrode material, an electrode, a lithium ion battery, and a method of producing an electrode material according to the present invention will be described.

These embodiments are merely specific examples for better understanding of the scope of the invention, and the invention is not limited thereto unless specified otherwise.

### Electrode-Active Material

An electrode-active material according to an embodiment of the invention includes sulfur or a sulfur compound in particles (hereinafter abbreviated as “LiₓA_{y}D_{z}PO₄ particles”) represented by LiₓA_{y}D_{z}PO₄ (wherein A represents one or two or more elements selected from the group consisting of Co, Mn, Ni, Fe, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x<2; 0<y<1; and 0≦z<1.5), in which a sulfur content in the particles is high in the centers of the particles and is low in the vicinity of surfaces of the particles.

In the LiₓA_{y}D_{z}PO₄ particles which are the electrode-active material particles, it is preferable that A represent Co, Mn, Ni, or Fe; and that D represent Mg, Ca, Sr, Ba, Ti, Zn, or Al from the viewpoints of high discharge potential, rich resources, safety, and the like.

The rare earth elements refer to 15 lanthanum-based elements of La, Ce, Pr, Nd, Pm, Sm, Eu, Gd, Tb, Dy, Ho, Er, Tm, Yb, and Lu.

The particle size of the electrode-active material particles is not particularly limited, but the average primary particle size thereof is preferably 0.01 μm to 20 μm and more preferably 0.02 μm to 5 μm.

When the average primary particle size is less than 0.01 μm, it is difficult to sufficiently coat the surfaces of the particles with a carbon thin film, the discharge capacity during high-speed charging and discharging is decreased, and it is difficult to realize sufficient charge-discharge performance. On the other hand, when the average primary particle size is greater than 20 μm, the internal resistance of the particles is increased, and the discharge capacity during high-speed charging and discharging is insufficient.

The average primary particle size described herein refers to the number average particle size. The average primary particle size of the particles can be measured using a laser diffraction/scattering particle size distribution analyzer.

The shape of the electrode-active material particles is not particularly limited, but is preferably spherical and particularly preferably true-spherical because an electrode material is easily formed of spherical particles, particularly, true-spherical secondary particles.

The reason why a spherical shape, particularly, a true-spherical shape is preferable as the shape of the electrode-active material is as follows. When an electrode-forming coating material or an electrode-forming paste is prepared by mixing an electrode material, a binder resin (binder), and a solvent with each other, the amount of the solvent can be reduced, and the electrode-forming coating material or the electrode-forming paste is easily coated on a current collector, the electrode material being obtained by allowing primary particles of the electrode-active material to aggregate such that secondary particles are formed and allowing carbon to be interposed between the primary particles.

In addition, it is preferable that the shape of the electrode-active material particles be spherical because the surface area of an electrode material prepared using the electrode-active material is minimal, the addition amount of a binder resin (binder) added to the electrode material can be minimized, and the internal resistance of the obtained cathode can be decreased.

Further, since the spherical particles are easily close-packed, the filling amount of a cathode material per unit volume is increased, the electrode density can be increased, and thus a high-capacity lithium ion battery can be provided.

The sulfur content in the electrode-active material particles is high in the centers and is low in the vicinity of the surfaces.

The sulfur content in the electrode-active material particles is preferably 100 ppm to 1000 ppm and more preferably 200 ppm to 800 ppm.

When all the sulfur is removed from the electrode-active material particles, defects caused by lattice distortions are eliminated. As a result, the diffusibility of lithium inside the particles deteriorates, which may decrease battery characteristics. By allowing a portion of sulfur to remain in the inside of the particles relating to the diffusion of lithium, particularly, in the center portions thereof, the diffusibility of lithium can be improved. On the other hand, in the vicinity of the surfaces of the particles, it is necessary that the sulfur content be decreased to promote the insertion and extraction of lithium.

By controlling the sulfur content in the electrode-active material particles to be in the above-described range, the electron conductivity of the electrode-active material particles is improved, and the diffusibility of lithium ions inside the particles is improved.

It is not preferable that the sulfur content of the electrode-active material particles be less than 100 ppm because the sulfur content of the electrode-active material particles is excessively small, and thus the electron conductivity of the electrode-active material particles is decreased. On the other hand, it is not preferable that the sulfur content of the electrode-active material particles be greater than 1000 ppm because the sulfur content of the electrode-active material particles is excessively large. As a result, when an electrode is prepared using the electrode-active material particles, the discharge capacity of a battery is decreased.

When a total sulfur content of the electrode-active material particles is represented by St,

a sulfur content in the vicinity of the surfaces of the electrode-active material particles which are dipped in hydrochloric acid having a mass ten times that of the electrode-active material particles and a pH of 3 for 5 minutes is represented by Sa1, and

a sulfur content in the vicinity of the surfaces of the electrode-active material particles which are dipped in hydrochloric acid having a mass ten times that of the electrode-active material particles and a pH of 3 for 10 minutes is represented by Sa2,

0.01≦Sa1/St≦0.1 and 0.01≦Sa2/St≦0.2 are satisfied.

In the electrode-active material particles, with respect to the total sulfur content St of the electrode-active material particles, the range of the sulfur content Sa1 in the vicinity of the surfaces of the electrode-active material particles which are dipped in hydrochloric acid having a pH of 3 for 5 minutes is narrower than the range of the sulfur content Sa2 in the vicinity of the surfaces of the electrode-active material particles which are dipped in hydrochloric acid having a pH of 3 for 10 minutes.

This shows that the elution amount of sulfur in the vicinity of the surfaces of the electrode-active material particles is extremely small with respect to the total sulfur content St of the electrode-active material particles. Accordingly, the sulfur content in the electrode-active material particles is high in the centers of the electrode-active material particles and is low in the vicinity of the surfaces thereof.

In order to measure the above-described sulfur contents St, Sa1, and Sa2, first, hydrochloric acid (pH=3) is prepared, and the electrode-active material particles are dipped in hydrochloric acid (pH=3) having a mass ten times that of the electrode-active material particles for 5 minutes and 10 minutes, respectively. Then, the total sulfur content St of the electrode-active material particles which are not dipped in hydrochloric acid, the sulfur content Sa1 in the vicinity of the surfaces of the electrode-active material particles which are dipped in hydrochloric acid for 5 minutes, and the sulfur content Sa2 in the vicinity of the surfaces of the electrode-active material particles which are dipped in hydrochloric acid for 10 minutes are measured using a sulfur analyzer, for example, a carbon-sulfur analyzer EMIR-320V (manufactured by Horiba Ltd.).

It is preferable that the surfaces of the electrode-active material particles be coated with a carbon coating film.

By coating the surfaces with the carbon coating film, the electron conductivity of the electrode-active material particles is improved.

The thickness of the carbon coating film is preferably 0.1 nm to 20 nm.

The reason why the thickness range of 0.1 nm to 20 nm is preferable is as follows. When the thickness of the carbon coating film is less than 0.1 nm, the carbon coating film is excessively thin, and thus it is difficult to improve the electron conductivity of the electrode-active material particles. On the other hand, when the thickness of the carbon coating film is greater than 20 nm, battery activity, for example, the battery capacity per unit mass of an electrode material may decrease.

### Electrode Material

An electrode material according to an embodiment of the invention is obtained by allowing primary particles of the electrode-active material according to the embodiment to aggregate such that secondary particles are formed and allowing carbon to be interposed between the primary particles.

The particle size of the electrode material is not particularly limited, but the average primary particle size thereof is preferably 0.01 μm to 20 μm and more preferably 0.02 μm to 5 μm.

When the average primary particle size is less than 0.01 μm, the crystallinity of the electrode material is decreased. As a result, the discharge capacity of the electrode material during high-speed charging and discharging is decreased, and it is difficult to realize sufficient charge-discharge performance. On the other hand, when the average primary particle size is greater than 20 μm, the diffusion length of lithiummoving through the inside of the particles of the electrode material is increased. As a result, the internal resistance of the electrode material is increased, and the discharge capacity during high-speed charging and discharging is insufficient.

Similarly to the case of the electrode-active material, the average primary particle size of the electrode material can be measured using a laser diffraction/scattering particle size distribution analyzer.

The shape of the electrode material is not particularly limited, but is preferably spherical and particularly preferably true-spherical.

The reason why a spherical shape, particularly, a true-spherical shape is preferable as the shape of the electrode material is as follows. When an electrode-forming coating material or an electrode-forming paste is prepared by mixing the electrode material, a binder resin (binder), and a solvent with each other, the amount of the solvent can be reduced, and the electrode-forming coating material or the electrode-forming paste is easily coated on a current collector.

In addition, it is preferable that the shape of the electrode material be spherical because the surface area of an electrode material is minimal, the addition amount of a binder resin (binder) added to the electrode material can be minimized, and the internal resistance of the obtained cathode can be decreased.

Further, since the spherical particles are easily close-packed, the filling amount of a cathode material per unit volume is increased, the electrode density can be increased, and thus a high-capacity lithium ion battery can be provided.

Similarly to the case of the electrode-active material particles, the sulfur content in the electrode material is preferably 100 ppm to 1000 ppm and more preferably 200 ppm to 800 ppm.

By controlling the sulfur content in the electrode material to be in the above-described range, the electron conductivity of the electrode material is improved, and the diffusibility of lithium ions is improved.

In the electrode material, similarly to the case of the electrode-active material particles, when a total sulfur content of the primary particles is represented by St,

a sulfur content in the vicinity of the surfaces of the primary particles which are dipped in hydrochloric acid (pH=3) having a mass ten times that of the primary particles for 5 minutes is represented by Sa1, and a sulfur content in the vicinity of the surfaces of the primary particles which are dipped in hydrochloric acid (pH=3) having a mass ten times that of the primary particles for 10 minutes is represented by Sa2,

0.01≦Sa1/St≦0.1 and 0.01≦Sa2/St≦0.2 are satisfied.

In the electrode material, similarly to the case of the electrode-active material, with respect to the total sulfur content St of the primary particles, the range of the sulfur content Sa1 in the vicinity of the surfaces of the primary particles which are dipped in hydrochloric acid (pH=3) for 5 minutes is narrower than the range of the sulfur content Sa2 in the vicinity of the surfaces of the primary particles which are dipped in hydrochloric acid (pH=3) for 10 minutes.

This shows that the elution amount of sulfur in the vicinity of the surfaces of the primary particles is extremely small with respect to the total sulfur content St of the primary particles. Accordingly, the sulfur content in the primary particles is high in the centers of the primary particles and is low in the vicinity of the surfaces thereof.

A secondary particle is obtained by allowing primary particles of the electrode-active material to aggregate, for example, is configured as a single structure formed by the primary particles in contact with each other aggregating and is in a state where the primary particles are strongly connected in a neck shape in which the contact area is small and the contact portion has a small cross-sectional area. Accordingly, when the electrode material is dipped in hydrochloric acid (pH=3), sulfur eluted in hydrochloric acid can be considered sulfur eluted from the primary particles.

In order to measure the above-described sulfur contents St, Sa1, and Sa2, first, hydrochloric acid (pH=3) is prepared, and the electrode material, that is, the primary particles thereof are dipped in hydrochloric acid (pH=3) having a mass ten times that of the primary particles for 5 minutes and 10 minutes, respectively. Then, the total sulfur content St of the primary particles which are not dipped in hydrochloric acid, the sulfur content Sa1 in the vicinity of the surfaces of the primary particles which are dipped in hydrochloric acid for 5 minutes, and the sulfur content Sa2 in the vicinity of the surfaces of the primary particles which are dipped in hydrochloric acid for 10 minutes are measured using a sulfur analyzer, for example, a carbon-sulfur analyzer EMIA-320V (manufactured by Horiba Ltd.).

As carbon to be interposed between the primary particles, a carbon coating film having a thickness of 0.1 nm to 20 nm is preferable.

It is not preferable that the thickness of the carbon coating film be less than 0.1 nm because the carbon coating film is excessively thin, and thus it is difficult to improve the electron conductivity of the electrode material on which the carbon coating film is formed. On the other hand, it is not preferable that the thickness of the carbon coating film be greater than 20 nm because battery activity, for example, the battery capacity per unit mass of an electrode material may decrease.

When the electrode material is evaluated, a 2032 coin cell having a 60 μm-thick electrode film is used, and a method of measuring the internal resistance of the electrode material with a current rest method is used. The internal resistance obtained in this way is preferably 20Ω or lower.

The reason for limiting the internal resistance to be 20Ω or lower is as follows. When the internal resistance is higher than 20Ω, it is necessary that the thickness of the electrode film be decreased to decrease the internal resistance as a battery, and thus the battery capacity per electrode is decreased. As a result, in order to obtain a desired battery capacity of the battery, it is necessary that the number of electrodes be increased.

It is not preferable that the number of electrodes be increased because the number of electrode members such as a current collector or a separator which have no battery activity is increased according to the number of electrodes, and thus the battery capacity is decreased.

### Method of Producing Electrode Material

A method of producing an electrode material according to an embodiment of the invention includes: a slurry-preparing process of preparing a slurry containing an electrode-active material or a precursor thereof and an organic compound, the electrode-active material containing sulfur or a sulfur compound in a compound represented by the above-described LiₓA_{y}D_{z}PO₄; a granulated body-forming process of spraying and drying the slurry to form a granulated body; and a heat treatment process of heating the granulated body in a reducing atmosphere in a temperature range from 500° C. to 1000° C.

Next, this production method will be described in detail.

### Slurry-Preparing Process

In the slurry-preparing process, a slurry containing an electrode-active material or a precursor thereof and an organic compound is prepared, the electrode-active material containing sulfur or a sulfur compound in a compound (hereinafter abbreviated as “LiₓA_{y}D_{z}PO₄ compound”) represented by LiₓA_{y}D_{z}PO₄.

The precursor of the electrode-active material is not particularly limited as long as LiₓA_{y}D_{z}PO₄ contains sulfur or a sulfur compound in the final process.

Similarly to the case of the electrode-active material, it is preferable that the LiₓA_{y}D_{z}PO₄ compound include LiₓA_{y}D_{z}PO₄ (wherein A represents one or two or more elements selected from the group consisting of Co, Mn, Ni, Fe, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x<2; 0<y<1; and 0≦z<0.5) as a main component.

In the LiₓA_{y}D_{z}PO₄ compound, it is preferable that A represent Co, Mn, Ni, or Fe; and that D represent Mg, Ca, Sr, Ba, Ti, Zn, or Al from the viewpoints of high discharge potential, rich resources, safety, and the like.

The LiₓA_{y}D_{z}PO₄ compound can be prepared using a method of the related art such as a solid-phase method, a liquid-phase method, or a gas-phase method.

The LiₓA_{y}D_{z}PO₄ compound which can be preferably used is prepared as follows. For example, a Li source selected from the group consisting of lithium salts such as lithium acetate (LiCH₃COO) or lithium chloride (LiCl) and lithium hydroxide (LiOH); a divalent iron salt such as iron chloride (II) (FeCl₂), iron acetate (II) (Fe(CH₃COO)₂), or iron sulfate (II) (FeSO₄); a phosphate compound such as phosphoric acid (H₃PO₄), ammonium dihydrogen phosphoate (NH₄H₂PO₄), or diammonium hydrogen phosphoate ((NH₄)₂HPO₄); and water are mixed to obtain a slurry mixture. The slurry mixture is hydrothermally synthesized using a pressure resistant sealed container, the obtained precipitates are washed with water to forma cake-shaped precursor material, and this cake shaped precursor material is baked to obtain the LiₓA_{y}D_{z}PO₄ compound.

The electrode-active material may be formed of crystalline particles or amorphous particles or may be formed of mixed particles of crystalline particles and amorphous particles.

The reason why the electrode-active material or the precursor thereof may be formed of amorphous particles is that the amorphous LiₓA_{y}D_{z}PO₄ compound is crystallized when being heated in a non-oxidizing atmosphere such as hydrogen at a temperature range of 500° C. to 1000° C.

The average particle size of the electrode-active material (primary particles) is not particularly limited, but is preferably 0.01 μm to 20 μm and more preferably 0.02 μm to 5 μm.

The reason for limiting the average particle size of the primary particles to the above-described range is as follows. It is not preferable that the average primary particle size be less than 0.01 μm because it is difficult to sufficiently coat the surfaces of the particles with a carbon thin film during the coating of the primary particle surfaces, the discharge capacity during high-speed charging and discharging is decreased, and it is difficult to realize sufficient charge-discharge performance. On the other hand, when the average primary particle size is greater than 20 μm, the internal resistance of the primary particles is increased, and the discharge capacity during high-speed charging and discharging is insufficient.

The shape of the primary particles is not particularly limited, but is preferably spherical and particularly preferably true-spherical because an electrode material is easily formed of spherical particles, particularly, true-spherical secondary particles.

The reason why a spherical shape, particularly, a true-spherical shape is preferable as the shape of the primary particles is as follows. The surface area of the electrode material is minimal, the addition amount of a binder resin (binder) added to the electrode material can be minimized, and the internal resistance of the obtained cathode can be decreased.

Further, since the spherical particles are easily close-packed, the filling amount of a cathode material per unit volume is increased, the electrode density can be increased, and thus a high-capacity lithium ion battery can be provided.

Similarly to the case of the electrode-active material particles, the content of sulfur or a sulfur compound in the primary particles is preferably 100 ppm to 1000 ppm and more preferably 200 ppm to 800 ppm in terms of sulfur.

By controlling the sulfur content in the primary particles to be in the above-described range, the electron conductivity of the electrode material is improved, and the diffusibility of lithium ions is improved.

The organic compound is not particularly limited as long as it can form a carbon coating film on the surface of the electrode-active material (primary particles), and examples thereof include polyvinyl alcohol, polyvinyl pyrrolidone, cellulose, starch, gelatin, carboxymethyl cellulose, methyl cellulose, hydroxymethyl cellulose, hydroxyethyl cellulose, polyacrylic acid, polystyrenesulfonic acid, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyether, and polyol.

Examples of the polyol include polyethylene glycol, polypropylene glycol, polyglycerin, and glycerin.

These organic compounds may be used alone or in a combination of two or more kinds.

As a solvent in the slurry, water is preferable. However, other solvents may also be used, and examples thereof include alcohols such as methanol, ethanol, 1-propanol, 2-propanol (isopropyl alcohol; IPA), butanol, pentanol, hexanol, octanol, or diacetone alcohol; esters such as ethyl acetate, butyl acetate, ethyl lactate, propylene glycol monomethyl ether acetate, propylene glycol monoethyl ether acetate, or γ-butyrolactone; ethers such as diethyl ether, ethylene glycol monomethyl ether(methyl cellosolve), ethylene glycol monoethyl ether (ethyl cellosolve), ethylene glycol monobutyl ether (butyl cellosolve), diethylene glycol monomethyl ether, or diethylene glycol monoethyl ether; ketones such as acetone, methyl ethyl ketone (MEK), methyl isobutyl ketone (MIBK), acetylacetone, or cyclohexanone; amides such as dimethyl formamide, N,N-dimethylacetoacetamide, or N-methyl pyrrolidone; and glycols such as ethylene glycol, diethylene glycol, or propylene glycol. These solvents may be used alone or in a combination of two or more kinds.

Regarding a blending ratio of the electrode-active material or the precursor thereof and the organic compound, the total amount of the organic compound in terms of the amount of carbon is preferably 0.6 parts by mass to 4.0 parts by mass and more preferably 1.1 parts by mass to 1.7 parts by mass with respect to 100 parts by mass of the electrode-active material.

When the blending ratio of the organic compound in terms of the amount of carbon is less than 0.6 parts by mass, the discharge capacity at a high charge-discharge rate is decreased during the formation of a battery, and it is difficult to realize sufficient charge-discharge rate performance. On the other hand, when the blending ratio of the organic compound in terms of the amount of carbon is greater than 4.0 parts by mass, lithium ion transfer resistance is increased due to stearic hindrance during the diffusion of lithium ions in the carbon coating film. As a result, during the formation of a battery, the internal resistance of a battery is increased, and a decrease in voltage at a high charge-discharge rate is not tolerable.

As a method of dissolving or dispersing the electrode-active material or the precursor thereof and the organic compound in the solvent, for example, a method using a medium stirring type dispersing machine, such as a planetary ball mill, a vibration ball mill, a bead mill, a paint shaker, or an attritor, capable of stirring medium particles (medium) at a high speed is preferable.

### Granulated Body-Forming Process

In the granulated body-forming process, the obtained slurry is sprayed and dried to form a granulated body.

In this process, using a spray drying machine such as a spray dryer, the above-described slurry is sprayed and dried in a high-temperature atmosphere, for example, in the air at a temperature range of 70° C. to 250° C. to form a granulated body.

In this spray drying method, in order to form a substantially spherical granulated body by rapid drying, the particle size of liquid drops during spraying is preferably 0.05 μm to 500 μm.

### Heat Treatment Process

In the heat treatment process, the granulated body obtained through the above-described processes is heated in a reducing atmosphere at a temperature of 500° C. to 1000° C.

In this case, the granulated body is heated in a reducing atmosphere at a temperature of 500° C. to 1000° C. and preferably 600° C. to 900° C.

The reason for limiting the heat treatment temperature to be 500° C. to 1000° C. is as follows. It is not preferable that the heat treatment temperature be lower than 500° C. because the decomposition and reaction of the organic compound is not sufficiently progressed, the carbonization of the organic compound is insufficient, and the obtained decomposition and reaction products are formed as high-resistance organic decomposition products. On the other hand, when the heat treatment temperature is higher than 1000° C., a component of the LiₓA_{y}D_{z}PO₄ compound constituting the electrode-active material, for example, lithium (Li) is evaporated and the composition is deviated. In addition, the grain growth of the LiₓA_{y}D_{z}PO₄ compound is promoted, the discharge capacity at a high charge-discharge rate is decreased, and it is difficult to realize sufficient charge-discharge rate performance.

As the reducing atmosphere, for example a hydrogen gas atmosphere containing 90 vol % of N₂ (for example, 3 vol % of H₂-97 vol % of N₂) is preferable because it is necessary that sulfur be removed from the surfaces of the primary particles constituting the granulated body.

The heat treatment time is not particularly limited as long as the organic compound is sufficiently carbonized, and for example, is 0.1 hours to 10 hours.

This granulated body contains lithium as a constituent element. Therefore, along with an increase in heat treatment time, lithium is dispersed from the electrode-active material or the precursor thereof contained in the granulated body to the carbon coating film, and thus lithium is present in the carbon coating film. As a result, the conductivity of the carbon coating film is further improved. For the above reasons, the granulated body is preferable.

However, it is not preferable that the heat treatment time be excessively increased because abnormal grain growth occurs, LiₓA_{y}D_{z}PO₄ particles in which a part of lithium is defected are formed, and thus the performance of the LiₓA_{y}D_{z}PO₄ particles is decreased, which causes deterioration in the characteristics of a battery prepared using the electrode-active material.

In addition, when a compound containing sulfur and lithium such as lithium sulfate (Li₂SO₄) is used as the sulfur compound, it is not necessary that lithium be diffused from the electrode-active material to the carbon coating film.

Through the above-described processes, the primary particles of the electrode-active material containing sulfur or the sulfur compound in the LiₓA_{y}D_{z}PO₄ particles are allowed to aggregate such that secondary particles are formed, and carbon is allowed to be interposed between the primary particles. As a result, the electrode material can be formed.

### Electrode

An electrode according to an embodiment of the invention includes the electrode material according to the embodiment.

In order to prepare the electrode according to the embodiment, the above-described electrode material, a binder formed of a binder resin, and a solvent are mixed to prepare an electrode-forming coating material or an electrode-forming paste. At this time, a conductive auxiliary agent may be optionally added.

Examples of the conductive auxiliary agent include thermal black, furnace black, lamp black, acetylene black, Ketjen black, carbon nanotube which is fibrous carbon, and vapor-grown carbon fiber. In particular, as carbon having high conductivity, acetylene black or Ketjen black is preferable. Acetylene black or Ketjen black is preferable from the viewpoint of easy availability.

As the binder, that is, the binder resin, for example, polytetrafluoroethylene (PTFE) resin, polyvinylidene fluoride (PVdF) resin, or fluororubber is preferably used.

A blending ratio of the binder resin to the electrode material is not particularly limited but, for example, is 1 part by mass to 30 parts by mass and preferably 3 parts by mass to 20 parts by mass with respect to 100 parts by mass of the electrode material.

A solvent used for the electrode-forming coating material or the electrode-forming paste may be appropriately selected according to the properties of the binder resin, and examples thereof include water; alcohols such as methanol, ethanol, 1-propanol, 2-propanol (isopropyl alcohol; IPA), butanol, pentanol, hexanol, octanol, or diacetone alcohol; esters such as ethyl acetate, butyl acetate, ethyl lactate, propylene glycol monomethyl ether acetate, propylene glycol monoethyl ether acetate, or γ-butyrolactone; ethers such as diethyl ether, ethylene glycol monomethyl ether(methyl cellosolve), ethylene glycol monoethyl ether (ethyl cellosolve), ethylene glycol monobutyl ether (butyl cellosolve), diethylene glycol monomethyl ether, or diethylene glycol monoethyl ether; ketones such as acetone, methyl ethyl ketone (MEK), methyl isobutyl ketone (MIBK), acetylacetone, or cyclohexanone; amides such as dimethyl formamide, N,N-dimethylacetoacetamide, or N-methyl pyrrolidone; and glycols such as ethylene glycol, diethylene glycol, or propylene glycol. These solvents may be used alone or in a combination of two or more kinds.

Next, the electrode-forming coating material or the electrode-forming paste is coated on a single surface of a metal foil, followed by drying. As a result, a metal foil with a single surface on which a coating film formed of a mixture of the electrode material and the binder resin is formed is obtained.

Next, this coating film is pressed and dried. As a result, an electrode including an electrode material layer on a single surface of the metal foil is prepared.

In this way, the electrode according to the embodiment can be prepared.

With this electrode, the electron conductivity can be improved, and the diffusibility of lithium ions inside particles can be improved. Accordingly, the discharge capacity at a high charge-discharge rate is increased, and sufficient charge-discharge rate performance can be obtained.

### Lithium Ion Battery

A lithium ion battery according to an embodiment of the invention includes: a cathode formed of the electrode according to the embodiment; an anode formed of metal Li, a Li alloy, Li₄Ti₅O₁₂, a carbon material, or the like; an electrolytic solution; and a separator or a solid electrolyte.

In this lithium ion battery, by preparing an electrode using the electrode material according to the embodiment, the insertion and extraction of Li are promoted, and thus high stability can be realized.

In addition, the electron conductivity can be improved, and the diffusibility of lithium ions inside particles can be improved. Accordingly, the discharge capacity at a high charge-discharge rate is increased, and sufficient charge-discharge rate performance can be obtained.

As described above, the electrode-active material according to the embodiment includes sulfur or a sulfur compound in particles represented by the LiₓA_{y}D_{z}PO₄ particles, in which a sulfur content in the particles is high in the centers of the particles and is low in the vicinity of surfaces of the particles. As a result, the electron conductivity can be improved, and the diffusibility of lithium ions inside the particles can be improved. In addition, regarding the sulfur content, the sulfur content in the particles is high in the centers of the particles and is low in the vicinity of surfaces of the particles. As a result, the ratio of sulfur in the vicinity of the surfaces of the particles is decreased, and thus the discharge capacity can be improved.

The electrode material according to the embodiment is obtained by allowing primary particles of the above-described electrode-active material to aggregate such that secondary particles are formed and allowing carbon to be interposed between the primary particles, in which the sulfur content is 100 ppm to 1000 ppm, and when a total sulfur content of the primary particles is represented by St, a sulfur content in the vicinity of the surfaces of the primary particles which are dipped in hydrochloric acid having a mass ten times that of the primary particles and a pH of 3 for 5 minutes is represented by Sa1, and a sulfur content in the vicinity of the surfaces of the primary particles which are dipped in hydrochloric acid having a mass ten times that of the primary particles and a pH of 3 for 10 minutes is represented by Sa2, 0.01≦Sa1/St≦0.1 and 0.01≦Sa2/St≦0.2 are satisfied. As a result, the electron conductivity can be improved, and the diffusibility of lithium ions inside the particles can be improved.

In addition, in order to satisfy 0.01≦Sa1/St≦0.1 and 0.01≦Sa2/St≦0.2, the total sulfur content St of the primary particles, the sulfur content Sa1 in the vicinity of the surfaces of the primary particles which are dipped in hydrochloric acid having a pH of 3 for 5 minutes, and the sulfur content Sa2 in the vicinity of the surfaces of the primary particles which are dipped in hydrochloric acid having a pH of 3 for 10 minutes are limited. As a result, the ratio of sulfur in the vicinity of the surfaces of the particles is decreased, and thus the discharge capacity can be improved.

The electrode according to the embodiment includes the above-described electrode material. As a result, the discharge capacity at a high charge-discharge rate can be increased, and sufficient charge-discharge rate performance can be obtained.

The lithium ion battery according to the embodiment includes a cathode formed of the above-described electrode. As a result, the discharge capacity at a high charge-discharge rate can be increased, and sufficient charge-discharge rate performance can be obtained.

### EXAMPLES

Hereinafter, the invention will be described in detail using Examples and Comparative Example, but the invention is not limited to these examples.

### Example 1

### Preparation and Evaluation of Electrode Material

4 mol of lithium acetate (LiCH₃COO), 2 mol of iron sulfate (II) (FeSO₄), and 2 mol of phosphoric acid (H₃PO₄) were mixed with 2 L of water such that the total amount was 4 L. As a result, a uniform slurry mixture was prepared.

Next, this mixture was placed in a pressure-resistant closed container having a volume of 8 L, followed by hydrothermal synthesis at 120° C. for 1 hour.

Next, the obtained precipitates were washed with water to form a cake-shaped precursor of an electrode-active material.

Next, 150 g (in terms of solid content) of the precursor of the electrode-active material and 5.5 g of polyethylene glycol as the organic compound were dissolved in 150 g of water, and this solution was mixed with 500 g of zirconia balls having a diameter of 5 mm as the medium particles, followed by dispersing with a ball mill for 12 hours. As a result, a uniform slurry was prepared.

Next, this slurry was sprayed and dried in the air at 180° C. to form a granulated body having an average particle size of 6 μm.

The obtained granulated body was calcined in a mixed gas atmosphere (3 vol % of H₂-97 vol % of N₂) at 700° C. for 1 hour. As a result, an electrode material (A1) of Example 1 was obtained.

This electrode material (A1) was pressed using a molding machine at 51 MPa to be molded into a disc shape having a size of diameter 20 mm×height 15 mm as a test sample. Next, electrodes were provided on both surfaces of the test sample, and the pressed powder resistance (Ω·cm) of the test sample was measured. The result was 10 Ω·cm.

When the electrode material (A1) was observed using a scanning electron microscope (SEM) and a transmission electron microscope (TEM), it was found that primary particles aggregated to form secondary particles, surfaces of the primary particles were coated with a carbon thin film, and carbon was interposed between the primary particles. In addition, the electrode material (A1) was a spherical body having an average particle size of 5 μm.

Further, the sulfur contents St, Sa1, and Sa2 of the electrode material (A1) were measured using a carbon-sulfur analyzer EMIA-320V (manufactured by Horiba Ltd.).

In this case, the electrode material (A1) was dipped in hydrochloric acid (pH=3) having a mass ten times that of the electrode material (A1) for 5 minutes and 10 minutes, respectively. Then, the total sulfur content St of the electrode material (A1) which was not dipped in hydrochloric acid, the sulfur content Sa1 in the vicinity of the surfaces of electrode material (A1) which was dipped in hydrochloric acid for 5 minutes, and the sulfur content Sa2 in the vicinity of the surfaces of electrode material (A1) which was dipped in hydrochloric acid for 10 minutes were measured, respectively. Based on the measurement results, Sa1/St and Sa2/St were calculated. As a result, in terms of sulfur (S), St=720 ppm, Sa1/St=0.043, and Sa2/St=0.073.

### Preparation and Evaluation of Lithium Ion Battery

The electrode material (A1), polyvinyl fluoride (PVdF) as the binder, and acetylene black (AB) as the conductive auxiliary agent were mixed with each other at a mass ratio of 90:5:5. Further N-methyl-2-pyrrolidinone (NMP) as the solvent was added to the mixture to impart fluidity. As a result, a slurry was prepared.

Next, this slurry was coated on an aluminum (A1) foil having a thickness of 15 μm, followed by drying. Next, the aluminum foil was pressed at a pressure of 600 kgf/cm². A cathode of a lithium ion battery of Example 1 was prepared.

Relative to the cathode of the lithium ion battery, lithium metal was disposed as an anode, and a separator formed of porous polypropylene was disposed between the cathode and the anode. As a result, a battery member was obtained.

Meanwhile, ethylene carbonate (EC) and ethyl methyl carbonate (EMC) were mixed at a volume ratio of 1:1 to obtain a mixed solution, and lithium hexafluorophosphate (LiPF₆) was dissolved in the mixed solution at a concentration of 1 mol/dm³. As a result, a non-aqueous electrolytic solution was prepared.

Next, the battery member was dipped in the non-aqueous electrolytic solution. As a result, a lithium ion battery of Example 1 was prepared.

The lithium ion battery was charged to 0.1 C at an environment temperature of 25° C. and was discharged to 3 C to measure the discharge capacity during high-speed charging and discharging. The result of the discharge capacity was 142 mAh/g.

### Example 2

An electrode material (A2) of Example 2 was obtained with the same method as that of Example 1, except that the obtained granulated body was calcined in a mixed gas atmosphere (5 vol % of H₂-95 vol % of N₂) at 700° C. for 1 hour.

The pressed powder resistance (Ω·cm) of the electrode material (A2) was 5 Ω·cm when measured with the same method as that of Example 1.

Similarly to the case of Example 1, when the electrode material (A2) was observed using a scanning electron microscope (SEM) and a transmission electron microscope (TEM), it was found that primary particles aggregated to form secondary particles, surfaces of the primary particles were coated with a carbon thin film, and carbon was interposed between the primary particles. In addition, the electrode material (A2) was a spherical body having an average particle size of 5.8 μm.

Further, the sulfur (S) contents of the electrode material (A2) satisfied St=650 ppm, Sa1/St=0.052, and Sa2/St=0.078 in terms of sulfur (S) when measured with the same method as that of Example 1.

Using the electrode material (A2), a lithium ion battery (A2) of Example 2 was obtained with the same method as that of Example 1. The discharge capacity of the lithium ion battery (A2) during high-speed charging and discharging was measured with the same method as that of Example 1. The result of the discharge capacity was 143 mAh/g.

### Example 3

An electrode material (A3) of Example 3 was obtained with the same method as that of Example 1, except that the obtained granulated body was calcined in a mixed gas atmosphere (8 vol % of H₂-92 vol % of N₂) at 700° C. for 1 hour.

The pressed powder resistance (Ω·cm) of the electrode material (A3) was 8 Ω·cm when measured with the same method as that of Example 1.

Similarly to the case of Example 1, when the electrode material (A3) was observed using a scanning electron microscope (SEM) and a transmission electron microscope (TEM), it was found that primary particles aggregated to form secondary particles, surfaces of the primary particles were coated with a carbon thin film, and carbon was interposed between the primary particles. In addition, the electrode material (A3) was a spherical body having an average particle size of 5.3

Further, the sulfur (S) contents of the electrode material (A3) satisfied St=625 ppm, Sa1/St=0.059, and Sa2/St=0.081 in terms of sulfur (S) when measured with the same method as that of Example 1.

Using the electrode material (A3), a lithium ion battery (A3) of Example 3 was obtained with the same method as that of Example 1. The discharge capacity of the lithium ion battery (A3) during high-speed charging and discharging was measured with the same method as that of Example 1. The result of the discharge capacity was 142 mAh/g.

### Example 4

An electrode material (A4) of Example 4 was obtained with the same method as that of Example 1, except that the obtained granulated body was calcined in a mixed gas atmosphere (10 vol % of H₂-90 vol % of N₂) at 700° C. for 1 hour.

The pressed powder resistance (Ω·cm) of the electrode material (A4) was 9 Ω·cm when measured with the same method as that of Example 1.

Similarly to the case of Example 1, when the electrode material (A4) was observed using a scanning electron microscope (SEM) and a transmission electron microscope (TEM), it was found that primary particles aggregated to form secondary particles, surfaces of the primary particles were coated with a carbon thin film, and carbon was interposed between the primary particles. In addition, the electrode material (A4) was a spherical body having an average particle size of 5.4 μm.

Further, the sulfur (S) contents of the electrode material (A4) satisfied St=595 ppm, Sa1/St=0.063, and Sa2/St=0.088 in terms of sulfur (S) when measured with the same method as that of Example 1.

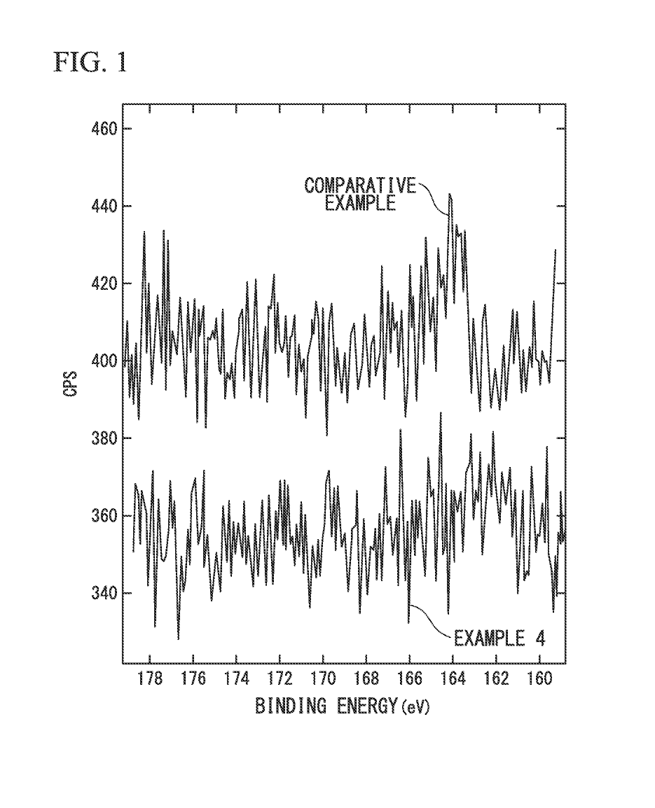

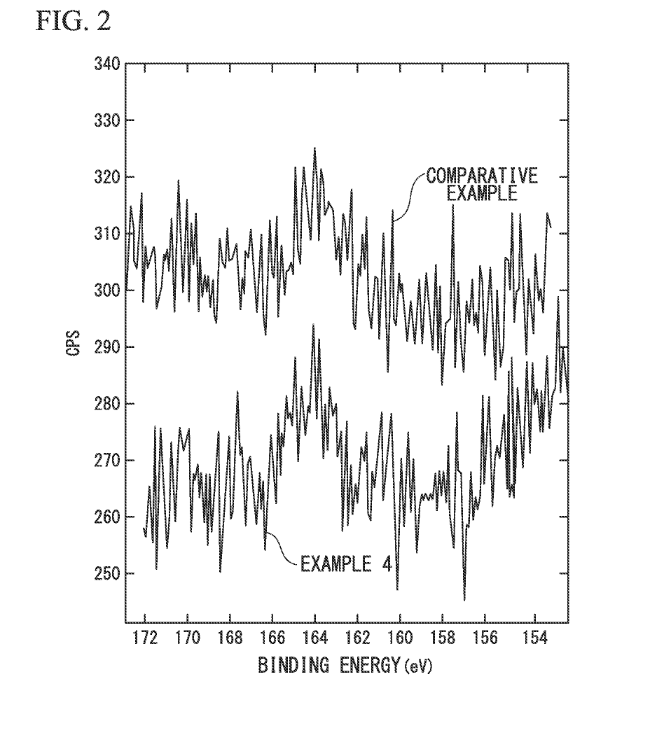

The electrode material (A4) was measured by X-ray photoelectron spectroscopy (XPS). FIG. 1 illustrates the results of the XPS measurement of the surfaces of the particles, and FIG. 2 illustrates the results of the XPS measurement of the inside (depth: 16 nm) of the particles. In these drawings, values of “CPS” in the vertical axis are relative values.

Using the electrode material (A4), a lithium ion battery (A4) of Example 4 was obtained with the same method as that of Example 1. The discharge capacity of the lithium ion battery (A4) during high-speed charging and discharging was measured with the same method as that of Example 1. The result of the discharge capacity was 147 mAh/g.

### Comparative Example

An electrode material (B1) of Comparative Example was obtained with the same method as that of Example 1, except that the obtained granulated body was baked in an inert atmosphere containing only nitrogen gas at 700° C. for 1 hour.

The pressed powder resistance (Ω·cm) of the electrode material (B1) was 2550 Ω·cm when measured with the same method as that of Example 1.

Similarly to the case of Example 1, when the electrode material (B1) was observed using a scanning electron microscope (SEM) and a transmission electron microscope (TEM), it was found that primary particles aggregated to form secondary particles, surfaces of the primary particles were coated with a carbon thin film, and carbon was interposed between the primary particles. In addition, the electrode material (B1) was a spherical body having an average particle size of 5 μm.

Further, the sulfur (S) contents of the electrode material (B1) satisfied St=1525 ppm, Sa1/St=0.15, and Sa2/St=0.24 in terms of sulfur (S) when measured with the same method as that of Example 1.

The XPS measurement of the electrode material (B1) was performed with the same method as the XPS measurement of Example 4. FIG. 1 illustrates the results of the XPS measurement of the surfaces of the particles, and FIG. 2 illustrates the results of the XPS measurement of the inside (depth: 16 nm) of the particles. In these drawings, values of “CPS” in the vertical axis are relative values. In addition, since the actual measurement results overlap with the measurement results of Example 4, only the range of the “CPS” values is moved upward to distinguish the actual measurement results from the measurement results of Example 4.

In addition, using the electrode material (B1), a lithium ion battery (B1) of Comparative Example was obtained with the same method as that of Example 1. The discharge capacity of the lithium ion battery (B1) during high-speed charging and discharging was measured with the same method as that of Example 1. The result of the discharge capacity was 119 mAh/g.

TABLE 1

| | | | | Pressed | |
|---|---|---|---|---|---|
| | | | | Powder | Discharge |
| | Sulfur Content (ppm) | | | Resistance | Capacity |
| | St | Sa1/St | Sa2/St | (Ω · cm) | (mAh/g) |
| Example 1 | 720 | 0.043 | 0.073 | 10 | 142 |
| Example 2 | 650 | 0.052 | 0.078 | 5 | 143 |
| Example 3 | 625 | 0.059 | 0.081 | 8 | 142 |
| Example 4 | 595 | 0.063 | 0.088 | 9 | 147 |
| Comparative | 1525 | 0.15 | 0.24 | 2550 | 119 |
| Example | | | | | |

It was found from Table 1 that the pressed powder resistances of the electrode materials of Examples 1 to 4 were greatly different from that of the electrode material of Comparative Example, and the conductivities of the electrode materials of Examples 1 to 4 were high.

In addition, when the batteries including the cathodes formed using the electrode materials of Examples 1 to 4 were compared to the battery including the cathode formed using the electrode material of Comparative Example, it was found that the discharge capacity during high-speed charging and discharging was high, stable charge-discharge performance was obtained, and high output performance was obtained.

In particular, in the battery including the cathode formed using the electrode material of Example 4 in which the sulfur content was small, battery characteristics were superior, and the discharge capacity was high. The reason is presumed to be that the amount of sulfur as an impurity was decreased, and the capacity corresponding to the amount was increased.

According to the XPS measurement results of FIGS. 1 and 2, a spectrum (S2P) derived from sulfur at 164 eV was not present in the surfaces of the particles of Example 4, whereas a spectrum (S2P) derived from sulfur at 164 eV was not present inside the particles. It was found from the above results that sulfur did not remain inside the particles.

On the other hand, a spectrum (S2P) derived from sulfur at 164 eV was present on both the surfaces and the inside of the particles of Comparative Example. It was found from the above results that sulfur remained on both the surfaces and the inside of the particles.

In the above-described examples, metal lithium was used as the anode to reflect the behavior of the electrode material on data. However, an anode material such as a carbon material, a lithium alloy, or Li₄Ti₅O₁₂ may be used. In addition, a solid electrolyte may be used instead of the electrolytic solution and the separator.

The electrode-active material according to the invention includes sulfur or a sulfur compound in particles represented by LiₓA_{y}D_{z}PO₄ (wherein A represents one or two or more elements selected from the group consisting of Co, Mn, Ni, Fe, Cu, and Cr; D represents one or two or more elements selected from the group consisting of Mg, Ca, Sr, Ba, Ti, Zn, B, A1, Ga, In, Si, Ge, Sc, Y, and rare earth elements; 0<x<2; 0<y<1; and 0≦z<1.5), in which a sulfur content in the particles is high in the centers of the particles and is low in the vicinity of surfaces of the particles. As a result, the electron conductivity can be improved, the diffusibility of lithium ions inside particles can be improved, and the discharge capacity can be improved. Accordingly, the electrode-active material according to the present invention is applicable to a next-generation secondary battery in which a decrease in size and weight and an increase in capacity are expected, and when being used for a next-generation secondary battery, the effects thereof are significantly high.

1. An electrode-active material, comprising
sulfur or a sulfur compound in particles represented by LiₓA_{y}D_{z}PO₄ (wherein A represents one or two or more elements selected from the group consisting of Co, Mn, Ni, Fe, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x<2; 0<y<1; and 0≦z<1.5),
wherein a sulfur content in the particles is high in the centers of the particles and is low in the vicinity of surfaces of the particles.

2. The electrode-active material according to claim 1,
wherein the sulfur content is 100 ppm to 1000 ppm, and
when a total sulfur content of the particles is represented by St,
a sulfur content in the vicinity of the surfaces of the particles which are dipped in hydrochloric acid having a mass ten times that of the particles and a pH of 3 for 5 minutes is represented by Sa1, and
a sulfur content in the vicinity of the surfaces of the particles which are dipped in hydrochloric acid having a mass ten times that of the particles and a pH of 3 for 10 minutes is represented by Sa2,
0.01≦Sa1/St≦0.1 and 0.01≦Sa2/St≦0.2 are satisfied.

3. The electrode-active material according to claim 1,
wherein the surfaces of the particles are coated with a carbon coating film.

4. An electrode material which is obtained by allowing primary particles of the electrode-active material according to claim 1 to aggregate such that secondary particles are formed and allowing carbon to be interposed between the primary particles,
wherein the sulfur content is 100 ppm to 1000 ppm, and
when a total sulfur content of the primary particles is represented by St,
a sulfur content in the vicinity of the surfaces of the primary particles which are dipped in hydrochloric acid having a mass ten times that of the primary particles and a pH of 3 for 5 minutes is represented by Sa1, and
a sulfur content in the vicinity of the surfaces of the primary particles which are dipped in hydrochloric acid having a mass ten times that of the primary particles and a pH of 3 for 10 minutes is represented by Sa2,
0.01≦Sa1/St≦0.1 and 0.01≦Sa2/St≦0.2 are satisfied.

5. An electrode, comprising
the electrode material according to claim 4.

6. A lithium ion battery, comprising
a cathode formed of the electrode according to claim 5.

7. A method of producing an electrode material, comprising:
preparing a slurry containing an electrode-active material or a precursor thereof and an organic compound, the electrode-active material containing sulfur or a sulfur compound in a compound represented by LiₓA_{y}D_{z}PO₄ (wherein A represents one or two or more elements selected from the group consisting of Co, Mn, Ni, Fe, Cu, and Cr; D represents one or two or more elements selected from the group consisting of Mg, Ca, Sr, Ba, Ti, Zn, B, Al, Ga, In, Si, Ge, Sc, Y, and rare earth elements; 0<x<2; 0<y<1; and 0≦z<1.5);
spraying and drying the slurry to form a granulated body; and
heating the granulated body in a reducing atmosphere in a temperature range from 500° C. to 1000° C.
